(19) United States
(12) Patent Application Publication
(10) Pub. No.: US 2006/0057328 A1
(43) Pub. Date: Mar. 16, 2006

(54) Carpet tile, installation, and methods of manufacture and installation thereof

(76) Inventors: Joseph Rocco Pacione, Newmarket (CA); John Anthony Pacione, Newmarket (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 10/543,905

(22) PCT Filed: Jan. 29, 2004
(86) PCT No.: PCT/CA04/00119

§ 371 Date: Sep. 30, 2005

Related U.S. Application Data
(60) Provisional application No. 60/443,576, filed on Jan. 30, 2003.

(51) Int. Cl. B32B 3/02; B32B 3/06; B32B 3/14; B32B 3/16

(52) U.S. Cl. 428/95; 428/88; 428/99; 428/100; 428/45; 428/47; 428/51; 428/52

(57) ABSTRACT

A carpet tile having a first layer of a non-woven primary backing having pile elements tufted through the backing to form loops on an underside of the backing is described. The tile includes a second layer of a secondary backing and having loops provided substantially across the underside of the secondary backing for attachment to hooks of a hook and loop attachment system. The tile further includes a hot melt binder which fastens the first and second layers to each other. The carpet tile is free of a stabilizing layer.

### FIELD OF THE INVENTION

The present invention relates to a carpet tile having loops substantially across its underside for attachment to a hooked underlayment. The invention also relates to manufacturing a carpet tile, installing the tile, and the installation itself.

### BACKGROUND OF THE INVENTION

Over the past several years, many attempts have been made at incorporating hook and loop (Velcro(™)) technology into floor coverings, particularly carpeting. There are several advantages to the use of such technology. It is environmentally friendly, permitting connection of flooring components in situ without the use of glues that release volatile organics. Hook and loop technology provides a robust connection, but one that is at the same time releasable, presenting advantages during installation and permitting replacement of damaged pieces, etc.

An earlier example of the use of hook and loop technology in the field of carpets is described in U.S. Pat. No. 4,822,658, which issued to Pacione on Apr. 14, 1989. The specification of this patent shows a carpet having loops across its underside for attachment along its edges by means of hooked strips secured to a floor to be covered by the carpet.

A variation of the approach described in the '658 patent specification involves the laying of carpet underpadding between hooked strips, as shown in the specification of U.S. Pat. No. 5,723,195, which issued to Pacione on Mar. 3, 1998.

It has been suggested to fasten by adhesive to a floor a holed hooked anchor tape that generally extends across the underside of an overlaid carpet connected to the tape by loops on its underside. This is shown in U.S. Pat. No. 5,382,462, which issued to Pacione on Jan. 17, 1995.

The specification of U.S. Pat. No. 6,217,974, which issued to Pacione on Apr. 17, 2001, describes a carpet having loops across its underside. This carpet includes a backing that incorporates a non-woven layer for dimensional stability.

More recently, use of anchor sheets to cover, more or less, an entire area to be carpeted has been described in U.S. Pat. No. 6,306,477, which issued to Pacione on Oct. 23, 2001. Such an anchor sheet is described in a more detailed way in international patent application No. PCT/CA 00/00681, that was published under WO 00/74544 on Dec. 14, 2000, and names Pacione as the inventor. Each of these cases describes a final carpet construction in which multiple carpet pieces are attached across the surface of an underlayment made up of multiple anchor sheets in which carpet pieces are located in part to span joins between neighboring anchor sheets. The present invention relates to such carpet pieces.

By way of further background, carpet tiles of many designs and constructions are already known.

For example, the specification of U.S. Pat. No. 6,203,881, which issued to Higgins on Mar. 20, 2001, describes a cushion backed carpet tile. The example set out in the specification describes a carpet having several characteristics typical of carpet tiles currently available commercially. There is a primary carpet layer made up of Nylon 6,6 loop pile continuous filament tufted into a nonwoven polyester backing. The primary carpet layer includes a precoat of SBR latex filled with 10 parts CaCO₂. Underlying the primary carpet layer is hot melt layer having laminated thereto a reinforcement layer which is at least partially embedded in a urethane foam layer. There is a final nonwoven backing, a polypropylene-polyester combination, secured to the foam layer.

Other carpet tiles are described in the specifications of the following patents:

| | | |
|---|---|---|
| U.S. Pat. No. 5,324,562 | Mullinax et al. | Jun. 28, 1994 |
| U.S. Pat. No. 5,348,784 | Lampert | Sep. 20, 1994 |
| U.S. Pat. No. RE 34,951 | Slosberg et al. | May 23, 1995 |

### SUMMARY OF THE INVENTION

The present invention includes a carpet tile having loops across its underside for attachment to an underlying substrate having hooks across its top side. A carpet tile of the present invention is particularly well suited for use in combination with an anchor sheet of the sort described in WO 00/74544.

As described in WO 00/74544, anchor sheets comprised of plastic expand and contract in response to environmental factors such as changes in atmospheric temperature or humidity. The sheets themselves are usually installed with small spaces in between each other. This spacing helps the installation to accommodate atmospheric changes by permitting dimensional adjustment to occur in the sheets. Any covering attached to the anchor sheets should be compatible with the anchor sheet underlayment in the sense that any stresses within the floor covering as a whole introduced by atmospheric changes should lead to a minimum amount of buckling and it should remain intact. Of course, the covering should also be sufficiently strong to mask imperfections of the underlayment, e.g., gaps between adjacent anchor sheets, and be resilient, to maintain its appearance through normal wear and tear, cleaning, etc.

The present invention includes a carpet tile, method of manufacturing the tile, an installation that includes the tile, and other related aspects of these inventions, as described further below.

Related to the invention(s) disclosed herein are invention(s) in the following United States provisional patent applications:
United States Provisional Patent Application entitled “System and methods of manufacturing hook-plates”, filed concurrently herewith and incorporated herein by reference;
United States Provisional Patent Application entitled “Improved anchor sheet”, filed concurrently herewith and incorporated herein by reference;
United States Provisional Patent Application entitled “Ultrasonic welding of resilient layers to plates”, filed concurrently herewith and incorporated herein by reference;
United States Provisional Patent Application entitled “Floor covering having a removable decorative inlay”, filed concurrently herewith and incorporated herein by reference; and
United States Provisional Patent Application entitled “Anchor sheet positioning and connection system”, filed concurrently herewith and incorporated herein by reference.

### BRIEF DESCRIPTION OF THE DRAWINGS

The invention is described below with reference to the attached drawings in which:

FIG. 1 is a sectional view of a carpet tile of the present invention;

FIG. 2 illustrates a carpet tile and anchor sheet installation;

FIG. 3 illustrates an anchor sheet; and

FIG. 4 illustrates the upper portion of a colored tile of the present invention.

### DETAILED DESCRIPTION AND PREFERRED EMBODIMENTS

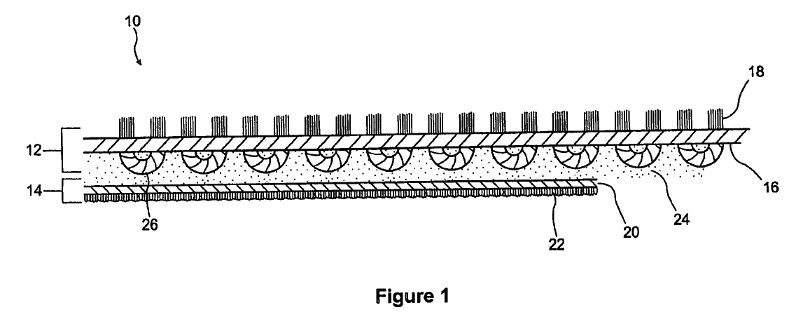

Turning to the drawings, FIG. 1 illustrates a carpet 10 of the present invention. The carpet is a laminate made up of an upper first layer 12 and a lower second layer 14.

The first layer 12 of the carpet includes a non-woven primary backing 16 into which is needled pile yarn 18. The second layer 14 includes secondary backing 20 to which are attached lower loops 22. The layers are secured to each other by hot-melt adhesive 24.

Primary backing 16 is a non-woven fabric. A non-woven fabric is a flat, flexible, porous sheet structure produced by interlocking layers or networks of fibers, filaments, or film-like filamentary structures, and such fabrics are known in the carpet industry. The fibers, or filaments, can be of natural and/or man-made fibers. Most commonly known are those of polyester, polypropylene, and rayon. The preferred materials here include polyester. Non-woven fibers can be directionally or randomly oriented fibers, bonded by friction, and/or cohesion, and/or adhesion, typically being fastened together by needle felting, thermal bonding, or ultrasonic welding. A particularly preferred material of the present invention is a commercially available product of Colbond Inc., Enka, N.C., U.S.A. sold under the name of Colback (™) Fabric as EZT120. Colback (™) is described by the manufacturer as a spunlaid nonwoven made from bicomponent filaments having a polyester core and a nylon 6 skin. The fabric is thermally bonded and has a weight of 120 g/m², but is available with unit weight ranging from 30 to about 250 g/m². Non-woven backings are used as primary carpet backings in the production of carpet tiles.

In the preferred embodiment, pile yarn 18 is tufted into primary backing 16. The yarn may be tufted into the backing by any of a number of conventional methods such as straight stitch, zigzag, etc. In the preferred embodiment, the pile is 1/10 gauge cut pile saxony. The pile has a height of 16.7 mm and weight of about 60 oz per square yard. Typically, the pile is cut by a conventional shearing method. Needling of the yarn through the primary backing leaves the underside of the first layer with tuft bundles of the yarn exposed, which bundles become anchored by the hot-melt adhesive, as described further below.

One preferred secondary layer is a tricot knit supplied by Guilford Mills, Inc. of Greensboro, N.C. The knit has the following characteristics:

| | Specification | Min | Max | Test Method |
|---|---|---|---|---|
| Finished width | 152 | 152 | 154 | ASTM D-3774-89 |
| Oz per sq yard | 3.05 | 3.66 | 4.04 | ASTM D-3776-85 |
| Wales per inch | 15 | 13 | 17 | ASTM D-3887-80 |
| Courses per inch | 76 | 72 | 79 | |
| Thickness | 0.024 | 0.014 | 0.034 | ASTM D-1777 |
| Peel (grams) | 225 | 150 | 300 | ASTM D-5 170 |
| Shear (grams) | 5,000 | 4,000 | 6,000 | ASTM D-5 169 |
| Ball burst | | 90 | | ASTM D-3787-80 |
| Flammability | Pass | | | 16 CFR 1610 |

| | | |
|---|---|---|
| Colorfastness | Dependent on shade | AATCC |
| Laundering: | | AATCC-61-1989 |
| shade change | | |
| Crocking: wet | | AATCC-8- 1989 |
| Lightfastness, | | AATTCC-16A-1990 |
| 20 hours | | |
| Acid perspiration: | | AATCC-15 |
| shade change | | |

Typically, such a tricot knit forms a dense substrate which provides for loops 22 on the underside of the secondary backing 20, which tricot precludes most, if not all, bleeding of hot melt 24 into the loops. Excessive bleeding, of course, is to be avoided as this could interfere with the function of the loops as fasteners.

Alternatively, the secondary backing 20 can be a non-woven plastic material having loops sown into it, as available from Scott & Fyfe Limited of Fife, Scotland. A suitable non-woven spun web polypropylene, 40 g/m², is used as a secondary backing. A two-ply layer can be used, in which case bleeding of the hot-melt into the loops is less. If a single layer is used, then a barrier film (not illustrated) can be applied to the non-woven material to preclude such bleed through. The loop yarn can be texturized polyethylene terephthalate (167 dTex; melting point of 250° to 260° C.) sewn through a polypropylene layer incorporated to the extent of 48 gm m² to provide protruding engagement loops for hook and loop attachment. The barrier film can be of polyethylene (melting point 105° to 115° C.) of 30 μm thickness, which amounts to about 27 gm m⁻².

First and second layers 12, 14 are attached to each other by hot melt adhesive 24 which also encapsulates tufts 26. One particular adhesive used is an ethylene-vinyl acetate-based adhesive known as XP-025 provided by Barrier-Bac, Inc. of Calhoun, Ga. The adhesive is free of filler, organic and inorganic, and has the following specifications:
Viscosity: 4,000-6,000 cps at 325° F. (163° C.)
Bail & Ring melt point: 240° F.±50 (115.5° C.)
   The adhesive is light brown in color and considered water resistant. A small amount of filler, e.g., bitumen, can be added to reduce costs. In accordance with standard manufacturing procedures, sufficient hot-melt EVA material is used to cause encapsulation tuft-bind and lamination of the secondary backing to the primary backing, but excessive EVA is avoided. Typically, a doctor blade is adjusted during manufacture to ensure delivery of the correct amount.

In an alternative embodiment, the upper layer is manufactured as indicated above, as is the lower layer, but they are manufactured separately, rather than being attached directly to each other by the hot melt adhesive. In such alternative embodiment, the layers may be attached by additional hot melt, acting as an adhesive, or by anther adhesive compatible with the hot melt on the underside of the primary backing. Of course, such a process can be a completely in-line process if desired.

In the preferred embodiment, the overall weight of the carpet of the present invention is approximately 80 to 100 oz per square yard. It will thus be appreciated that it is possible, according to the invention, to have a carpet, and carpet tile, with a relatively light weight secondary backing. Such a backing lacks a stabilizing layer and, as is explained below, is relatively free of filler. Such a carpet or carpet tile has little or no inherent dimensional stability of its own in relation to externally applied physical forces, such as stretching forces, forces exerted in use by rolling machinery, furniture movement, etc. The carpet relies on the anchor sheet for such physical stability. The carpet can thus be usefully employed in a system where there is 100% attachment of loops 22 across the undersurface by hooks that are part of a stable structure, such as an anchor sheet described in U.S. Pat. No. 6,306,477 attached to a floor, or the anchor plate described in international patent application No. PCT/CA 00/00681 published under WO 00/74544 on Dec. 14, 2000 and Sep. 20, 2001.

Given the foregoing description, a person skilled in the art is capable of manufacturing the carpet laminate. The carpet laminate would typically be manufactured in an in-line process to form a webbing approximately 12 feet in width. However, any convenient width, e.g. 6, 12, 15 feet, etc., can be used. The carpet may be rolled onto large spools for storage, shipment, etc., as desired.

According to the invention, the carpet laminate can eventually be cut into tiles at some convenient point. This may be immediately after manufacture, but may be later, as for example, after an order for a specific color, shape or size, of tile has been received by a manufacturer.

This can considerably ease inventory management problems. With this carpet, combined with a field of hooks, described below, it is possible to make a tile of any shape and size to order. Even small carpet tiles, e.g., 2″×2″, can be easily incorporated into a carpet installation. The carpet laminate can be cut through the back or the front by, for example, an ultrasonic cutter on a plotting table. The cutter can be controlled by software to make any form of pattern or design. One such cutter is available through Eagle Automation, Inc. of Exton, Pa. (see U.S. Pat. No. 6,440,787, which issued to Becan et al. on Aug. 13, 2002), or from AXYZ Automation on South Service Road in Burlington, Ontario, Canada. Since the carpet has edge integrity, as described below, it can be cut at any point and is immediately usable as a carpet tile, when installed onto a field of hooks. Generally, however, the edge is bevelled, as described below.

It is believed that the laminate carpet of the preferred embodiment has especially desirable characteristics for formation into a carpet tile, not the least of which is that the cutting process described above results in clean edges that are resistant to ravelling and wear. It is believed that the hot-melt adhesive and a relatively low level of filler contributes to this resistance to wear. The preferred embodiment hot-melt adhesive is substantially free of filler (e.g., calcium carbonate, magnesium carbonate, calcium sulfate, barium sulfate, silica, flyash, clay, bitumen, etc.) which is typically incorporated into the adhesive layer intermediate the primary and secondary backings of a carpet or carpet tiles. Filler, which can conventionally make up up to 75 percent or more of such a carpet adhesive layer, can increase the friability of the adhesive layer, leading to fraying or separation of the bonded layers at the edges. This is especially true over time as the filler is “walked out” of the intermediate layer and the adhesive wears down. The edges of a carpet tile of the present invention, having a clean cut edge, will generally remain intact for the expected lifetime of the tile, without the need for sewing shut of the edge, a sealant or supplemental adhesive to ensure against lack of separation of the primary and secondary backings. While it is often preferred that the adhesive contain no filler, a carpet tile of the present invention can contain filler up to an extent that maintains edge integrity. Any filler will impair edge integrity to some extent, but small amounts can be added depending on the quality of carpet tile that is desired.

A preferred tile of the present invention thus has cut edges that are otherwise unfinished. An “unfinished”edge is one in which steps have not been taken subsequent to the cutting step to maintain the integrity of the interface of the primary and secondary backings along the edge. In other words, the edges of the tile have not subsequently been treated by, for example, serging to preclude delamination of the primary and secondary layers in use. The term, however, does not exclude cosmetic changes, such as bevelling of the pile along the edge of the tile. A wide-width carpet can thus be manufactured according to specifications described above and a tile of the invention cut therefrom (and the pile edges optionally bevelled) which is ready for use without further treatment.

Carpet tiles so obtained can be any shape, and will typically be a regular geometric shape which can be combined with other tiles to fill a floor space. Any suitable dimension or geometric shape, as desired, can be obtained by a person skilled in the art. For example, squares measuring anywhere from 2″×2″ to about 36″×36″ in exterior (plan) dimension can be cut. Regular hexagons or equilateral triangles of the same shape can be combined with each other, but there is no need to use a single shape. For example, octagons in combination with appropriately sized square tiles can be used, or a completely customized group of tiles can be cut.

One carpet tile, typical of the invention is 16″×16″, with cut saxony pile ½″ in height and is bevelled along each of its edges. The interior angle 28 of the bevel is about 30°.

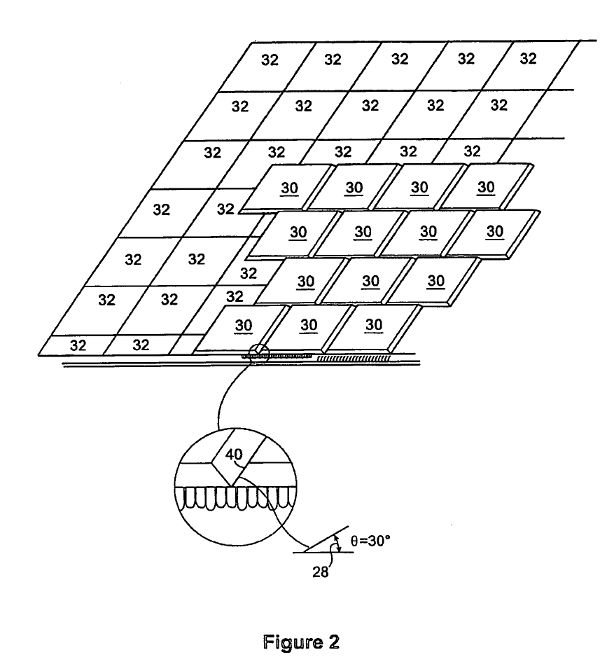

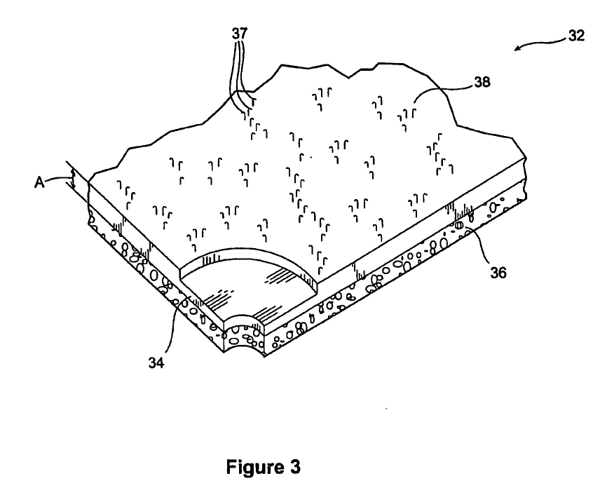

FIG. 2 shows carpet tiles 30 of the present invention installed with underlying anchor sheets 32. As mentioned above, a carpet tile of the present invention is particularly suited for use with anchor sheets of the sort described in WO 00/74544 published Dec. 14, 2000, and United States patent applications entitled “System and methods of manufacturing hook-plates”, “Improved anchor sheet”, and “Ultrasonic welding of resilient layers to plates”, detailed above. The sheets can be secured and/or located with respect to each other during installation as described in United States patent application entitled “Anchor sheet positioning and connection system”, detailed above. An anchor sheet suitable for use with a covering of the present invention, or as part of the present invention, illustrated in FIG. 3, is described as follows.

The thickness A is ⅛ of an inch (0.125 inches), and the thickness of the anchor sheet at 34 is 1/16 of an inch (0.0625 inches). The corner of the anchor sheet includes a countersunk area attachment, if desired to other anchor sheets, or to an underlying floor, as described in WO 0/74544. The thickness of the cushion 36 will be either approximately ¼ of an inch or 3/8 of an inch depending on the desired resiliency and amount of surface traffic. Hooks 37 of the top surface layer 38 will have a density that may range from 160-1200 hooks per square inch, with one preferred density of approximately 230 hooks per square inch.

A suitable material for the layer 38 is polypropylene and the cushion 36 is polyethylene, with further details provided in the United States patent application entitled “Improved anchor sheet”.

In one embodiment, the cushion 36 is made from linear low density polyethylene with a density of approximately 30 kg/m³ (about 2.1 lb/ft³).

The anchor sheets 32 may be any size convenient for sale, transportation or installation. If the anchor sheet is square, then typically it is in the range of 12″×12″ to 36″×36″. In a preferred embodiment, anchor sheet 32 is approximately 25″×25″ square. In a second preferred embodiment, anchor sheet 32 is approximately 26″×26″ square.

In a preferred aspect of the invention, edges 40 of pile elements are bevelled. The cutting of the pile in such a tapered fashion is preferably conducted after the cutting step in which the edge of the tile is formed by the cutting of the backing layers. Tapered cutting, or bevelling of pile of carpet pieces is well known in the art. For example, National Carpet Equipment of 6801 Winnetka Avenue North, Minneapolis, Minn. sells a carpet beveller which uses a rotating blade that can bevel the edge of a carpet after cutting.

It is generally possible to obtain cleanly sheared edges, and it is also possible for the face of the carpet to have designs cut into it. It will be appreciated, however, that threads of carpet pile together often have a slight lean to them. It will thus be appreciated that a less than perfect pile cut might be obtained when pile is sheared along an edge where the pile is leaning over the edge (i.e., away from the center area of the carpet). Under these circumstances, a fuzzy edge may be obtained, particularly along the base of the pile. This problem is addressed by trimming the fuzz prior to the bevelling step.

The carpet tile of the present invention can provide advantages over certain previous tiles. A carpet tile of the present invention is obtained directly by cutting the tile from a large web of material. It is possible to cut the tile from such a larger stock piece with the dimensions (i.e., length or width from edge to edge) that it is required to have for installation. In other words, the tile can be installed with such “unfinished” edges, i.e., without treatment of the edge. This means that tiles cut with complementary edges can be installed side-by-side to each other directly onto a hooked underlayment without edge treatment.

In any event, tiles of the present invention that have an unfinished edge can be directly applied to a hooked underlayment make it possible for a consumer to design their own carpet, have the carpet tiles cut according to the design, so that they can be directly installed. The pile along the carpet edges can also be conveniently bevelled, as described above. Because a “semi-permanent” covering installation is obtained with hook and loop technology, individual pieces can be adjusted or replaced without necessarily disturbing adjacent tiles, or the underlayment itself.

One embodiment of the invention is thus a method of designing and manufacturing tiles for a carpet covering. A consumer is provided access to a computer programmed with graphics software capable of generating an on-screen depiction of a carpet covering made up of carpet tiles. The carpet tiles are of cut pile. The covering is made up of different sections, each corresponding to a carpet tile. Each tile can be of a color different from that of its neighboring tile(s), or the tiles can have the edges sheared or bevelled so that neighboring tiles are divided by troughs. Combinations of these types of tiles can be included in the covering. The computer programme permits the user to visualize the carpet covering and to manipulate the depiction of the carpet in order to select a carpet designed according to their own requirements and tastes. Thus, the overall size and shape of the carpet covering can be selected, the size and shape of tiles that make up the covering can be varied, as can be the color of each tile and the shape of the cut pile edge (straight bevel, rounded chamfer, etc.). Once a final carpet covering is selected, its specifications can be electronically stored. The specifications can be used in the manufacture of the tiles, both to make the entire covering or later to make replacement tiles. The stored values are thus fed as needed to the computer of a machine which can cut carpet and shear carpet pile under control of the computer. A stock carpet piece of the selected color for each section of the carpet is fed to the machine and the tile cut to the selected specifications. Computer-controlled laser cutting of upper components (e.g., yarn secured to a backing) for incorporation into a carpet tile is described, for example, in U.S. Pat. No. 5,324,562, which issued to Mullinax et al on Jun. 28, 1994.

All of the carpet tiles are thus cut and sheared according to the designer's specifications. These are assembled and shipped to the site for installation. The installation may be done by a professional carpet installer, or possibly, the consumer themselves.

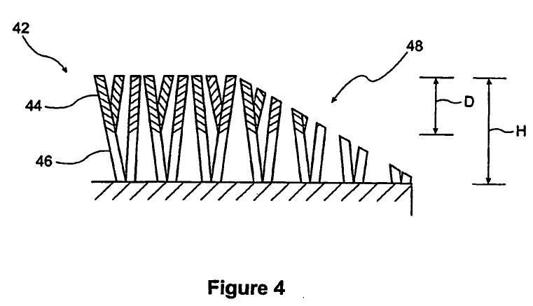

A particular embodiment of the invention is a carpet piece, preferably a carpet tile, and method of manufacture thereof, in which pile visible to the eye when the piece is viewed from above presents more than one color. The upper portion 42 of such a tile is illustrated (not to scale) in FIG. 4.

The carpet piece has a cut pile face. The pile is at least two colors. The first color 44 extends to a partial depth “D” below the visible face and the second color 46 is below the first color. The face is partially cut away to visually expose the second color. The printing process can be carried out using any suitable conventional coloring process, for example, using the Chromojet™ jet printer available from Zimmer Maschinebau GesmbH Klagenfurt, Ebentalerstraβe 133, A-9020 Klagenfurt, Austria.

In one such embodiment, a stock piece of carpet having a base color, of tan, for example, is printed with a variety of colors (e.g. rust, terra cotta, brown etc.) which colors are predominantly darker than the base color and penetrate the pile to a partial depth “D” below the visible face and the lighter base color is therebelow. The carpet is cut into tiles of any convenient shape or shapes. The pile along the tile edges are bevelled to expose the color of the lower layer along bevelled pile edges 48. The carpet tiles are mixed with each other in a randomization process, as by addition to a container followed by agitation of the container, or by random packaging on the production line, etc. Tiles are retrieved from the randomized group and sequentially installed onto anchor sheets. The resultant tiles if rectangular, for example, can be laid in a herringbone or brick like pattern to give a brick like terra cotta appearance.

In one embodiment, a stock piece of carpet having a base color (e.g. white, tan, light yellow etc.) is colored on its face with another color. Generally, the base color is lighter than the color on the face, and could even be raw (un-dyed) pile yarn, which can be light grey, for example. When the carpet is cut into pieces and the pile edges 48 bevelled, the lighter base color appears around the edges of the tile creating a grout-like or highlighted appearance. When the tiles are layed side by side, the decorative pattern formed by the abutting tile edges is highlighted by the contrasting colors.

As is required, or otherwise desirable, this description of the invention is addressed to the skilled person, and so the terms used herein are used as they would be understood by such person in the context presented. For the sake of clarity, the following terms have been assigned the specific meanings indicated.

For the purposes of this description and particularly in the claims, the term “comprising” is intended to be taken in an open-ended sense, unless its context would dictate otherwise. A composition comprising a combination of A and B is thus intended, for example, to include a composition made up of A and B, or A, B and C, or A, B, C and D, etc.

A. “carpet tile” is a carpet piece of such weight and dimension that it can be carried about and installed with other carpet tiles by a single person. This is in contrast to rolled goods, the sort of which are installed as part of wall-to-wall installations. A tile is often a simple geometric shape, but can be any desired shape. A “carpet tile” thus generally has a maximum size of 4 square meters, but is more typically on the order of 0.1 to 0.2 square meters in overall area. An example of a tile is one that is 576 square inches, i.e., has the area of a 24″×24″ square tile.

Also, the term “sheared pile” is used herein as would be generally understood by the skilled person. For clarity, however, “sheared” or “cut” pile is made up of fibres that have free (non-looped) upper ends, as result from cutting of loops tufted into a carpet backing.

Pile “height” is the distance between the upper end or tip of the pile and the top surface of the primary backing to which the pile is secured, again as is understood in the carpet industry.

A “stabilizing layer” is a layer of relatively rigid material that is commonly present in conventional carpet tiles. Typically, a stabilizing layer is a layer of fiberglass embedded in a plastic, often PVC, layer. A stabilizing layer is included as part of a carpet tile to impart dimensional stability to the tile as explained in the patent literature. See, for example, U.S. Pat. No. 6,203,881, which issued Mar. 20, 2001 to Higgins, U.S. Pat. No. 5,348,784, which issued Sep. 20, 1994 to Lampert, U.S. Pat. No. 4,915,999, which issued Apr. 10, 1990 to Tillotson, U.S. Pat. Reissue No. 34,951, which issued May 23, 1995 to Slosberg et al. and U.S. Pat. No. 5,965,232, which issued Oct. 12, 1999 to Vinod.

All documents mentioned in this description are incorporated herein by reference as though their entire contents were reproduced herein. Further, Applicant reserves the right to incorporate any part of any document mentioned herein into this specification for at least as long as the application is pending.

The scope of protection sought for any invention described herein is defined by the claims which follow. It will be appreciated by those skilled in the art that a variety of possible combinations and subcombinations of the various elements described herein exist, and all of these combinations and subcombinations should be considered to be within the inventor's contemplation though not explicitly enumerated here. This is also true of the variety of aspects of the processes and the combinations and subcombinations of elements thereof.

1. A carpet tile comprising:
(i) a first layer comprising a non-woven primary backing having pile elements tufted through the backing to form loops on an underside of the backing;
(ii) a second layer comprising a secondary backing and having loops provided substantially across the underside of the secondary backing for attachment to hooks of a hook and loop attachment system; and
(iii) hot melt binder which fastens the first and second layers to each other; wherein:
(iv) the tile is free of a stabilizing layer.

2. A carpet tile comprising:
(i) a first layer comprising a non-woven primary backing having pile elements tufted through the backing to form loops on an underside of the backing;
(ii) a second layer comprising a secondary backing and having loops provided substantially across the underside of the secondary backing for attachment to hooks of a hook and loop attachment system; and
(iii) hot melt binder which fastens the first and second layers to each other; wherein:
(iv) the tile is free of a cushion layer.

3. A carpet tile comprising:
(i) an upper portion having a first layer comprising a primary backing having cut-pile elements secured thereto, and
(ii) a lower portion consisting essentially of:
(a) a secondary backing with loops provided substantially across the underside of the secondary backing for attachment to hooks of a hook and loop attachment system; and
(b) hot melt binder which fastens the first and second layers to each other.

4. A carpet tile comprising:
(i) a first layer comprising a non-woven primary backing having pile elements tufted through the backing to form loops on an underside of the backing;
(ii) hot melt binder on the underside of the first layer which fastens the loops to the primary backing; and
(iii) a second layer affixed to the first layer, the second layer comprising a secondary backing and having loops provided substantially across the underside of the secondary backing for attachment to hooks of a hook and loop attachment system; wherein:
(iv) the tile is free of a stabilizing layer.

5. The carpet tile of claim 1 wherein the pile elements are sheared.

6. The carpet tile of claim 5, wherein the pile elements have a height of at least about 0.1 inches.

7. The carpet tile of claim 6, wherein the pile elements have a height of at least about 0.15 inches.

8. The carpet tile of claim 6, wherein the pile elements have a height of at least about 0.2 inches.

9. The carpet tile of any of claim 6, wherein the pile elements have a height of at least about 0.25 inches.

10. The carpet tile of claim 6, wherein the pile elements have a height of up to about 1 inch, or of up to about 0.9 inches, or of up to about 0.8 inches, or of up to about 0.7 inches, or of up to about 0.6 inches, or of about ½ inch.

11. The carpet tile of claim 1, wherein the primary backing has unfinished cut edges.

12. The carpet tile of claim 3, wherein the pile along at least one of the edges of the tile is bevelled.

13. The carpet tile of claim 12, wherein the pile along all edges of the tile is bevelled.

14. The carpet tile of claim 1, wherein the tile is free of a cushion layer.

15. The carpet tile of claim 1, wherein said hot melt binder comprises an ethylene-vinyl acetate c-polymer based adhesive composition.

16. The carpet tile of claim 2, wherein the tile is free of a stabilizing layer.

17. The carpet tile claim 1, wherein the pile elements comprise nylon.

18. The carpet tile of claim 1, wherein the tile has a surface area of up to about 3½ square meters, or up to about 3 square meters, or up to about 2½ square meters, or up to about 1 square meter, or up to about ½ square meters.

19. The carpet tile of claim 18, wherein the tile has a surface area at least about 1/50 square meters, or at least about 1/25 square meters, or at least about 1/10 square meters, or at least about ⅕ square meters, or at least about ¼ square meters, or at least about ⅓ square meters.

20. The tile of claim 18, wherein the tile is at least 5 cm wide, and up to 3 meters in length, or wherein the tile is up to 2 meters in length, or wherein the tile is up to 1 meter in length, or wherein the tile is at least 10 cm in width and up to 1 meter in length, or wherein the tile is at least 10 cm in width.

21. The tile of claim 1, wherein the tile is in the shape of a triangle, rectangle, rhombus, pentagon, hexagon or octagon.

22. The tile of claim 1 wherein the second layer further comprises a barrier film to preclude substantial penetration of said binder into the loops.

23. The tile of claim 1, wherein the second layer consists essentially of said secondary backing and loops, and the barrier film, if any.

24. The tile of claim 23, wherein the mass of the second layer is up to about 10 oz per square meter, or up to about 9 oz per square meter, or up to about 8 oz per square meter, or up to about 7 oz per square meter, or up to about 6 oz per square meter, or up to about 5 oz per square meter, or up to about 4 oz per square meter, or up to about 3 oz per square meter.

25. The tile of claim 1, wherein the mass of the tile is up to about 200 oz per square meter, or up to about 180 oz per square meter, or up to about 170 oz per square meter, or up to about 160 oz per square meter, or up to about 150 oz per square meter, or up to about 140 oz per square meter, or up to about 130 oz per square meter, or up to about 120 oz per square meter, or up to about 110 oz per square meter, or up to about 100 oz per square meter.

26. The tile of claim 25, wherein the mass of the tile is at least 50 oz per square meter, or at least 55 oz per square meter, or at least 60 oz per square meter, or at least 65 oz per square meter, or at least 70 oz per square meter, or at least 75 oz per square meter, or at least 80 oz per square meter.

27. The tile of claim 1, wherein the loops comprise a tricot knit.

28. The tile of claim 1, wherein said pile elements comprise cut pile saxony.

29. The carpet tile of claim 3, wherein the pile is bevelled along all edges of the tile and bevel forms an internal angle with the secondary backing of between 20° and 70°, or between 20° and 60°, or between 30° and 70°, or between 30° and 60°, or between 30° and 50°, or between 40° and 50°, or about 20°, or about 30°, or about 40° or about 45°, about 50°, or about 55° or about 60°.

30. The carpet tile of claim 3, wherein the pile along at least one edge of the tile has a rounded portion formed by shearing of the pile, the rounded portion having an internal radius of curvature of less than 4 times the height of the pile, or less than 3 times the height of the pile, or less than 2 times the height of the pile.

31. A carpet tile comprising:
(i) a first layer comprising a non-woven primary backing having pile elements tufted through the backing to form loops on an underside of the backing;
(ii) a second layer comprising a secondary backing and having loops provided substantially across the underside of the secondary backing for attachment to hooks of a hook and loop attachment system; and
(iii) hot melt binder which is substantially free of filler and tuft-binds the pile elements to the primary backing and fastens the first and second layers to each other.

32. The carpet tile of claim 31, wherein the tile has unfinished cut edges.

33. A carpet tile consisting essentially of:
(i) a first layer having a non-woven primary backing and cut pile elements tufted through the backing to form loops on an underside of the backing;
(ii) a second layer having a secondary backing and having loops provided substantially across the underside of the secondary backing for attachment to hooks of a hook and loop attachment system;
(iii) hot melt binder which tuft-binds the pile elements to the primary backing and fastens the first and second layers to each other; and optionally, a barrier to preclude substantial penetration of the binder into the loops; and wherein:
(iv) the binder contributes no more than 60 percent the total weight of the tile.

34. The tile of claim 33, wherein the binder contributes no more than 55 percent, or no more than 50 percent to the total weight of the tile.

35. The tile claim 34, wherein the binder contributes no more than 45 percent of the total weight of the tile.

36. The tile of claim 33, wherein the total weight of the carpet is up to 120 oz per square yard.

37. A carpet tile comprising:
(i) a first layer having a non-woven primary backing and cut pile elements tufted through the backing to form loops on an underside of the backing;
(ii) hot melt binder which tuft-binds the pile elements to the primary backing; and
(iii) a second layer having a topside permanently affixed to the first layer, the second layer comprising a secondary backing and loops provided substantially across the underside of the secondary backing for attachment to hooks of a hook and loop attachment system; optionally, a barrier to preclude substantial penetration of the binder into the loops; and wherein:
(iv) the total weight of the carpet is up to 120 oz per square yard.

38. A carpet installation, comprising:
an underlayment comprising a plurality of anchor sheets, each anchor sheet having hooks of a hook and loop attachment system across an upper side thereof;
a plurality of cut-pile carpet tiles covering the underlayment, each carpet tile having loops of the hook and loop attachment system across a lower side thereof in engagement with the hooks of the underlying anchor sheets; wherein:
the carpet tiles are located on the anchor sheet with adjacent edges of the tiles together forming a decorative pattern, and portions of the pile along said edges of the carpet tiles are sheared so as to make visible said decorative pattern.

39. The installation of claim 38, wherein the carpet comprises a first layer comprising a non-woven primary backing having pile elements tufted therethrough to form loops on an underside of the backing, the loops are secured to an underside of a secondary backing of a second layer, and the first and second layers are secured to each other by a hot-melt binder and the pile elements are tuft-bonded to the primary backing by the hot-melt binder.

40. The installation of claim 38, wherein the adjacent edges of the tiles are cut and unfinished.

41. The installation of claim 38, wherein pile along edges of the tiles are bevelled.

42. The installation of claim 38, wherein each anchor sheet includes a cushion on the reverse side to the upper side and each of the carpet tiles does not have a cushion.

43. The installation of claim 42, wherein each anchor sheet has an upper layer comprising polyproylene, preferably injection-molded polypropylene.

44. The installation of claim 38, wherein the carpet tiles are as defined in any claims 1 to 37, and/or wherein the anchor sheets are as defined in claim 42 or 43.

45. A method of installing a floor covering, the method comprising the steps of:
(a) installing a hooked underlayment across an area of floor to be covered;
(b) providing a plurality of carpet tiles individually shaped such that together the tiles can be laid side-by-side to cover the area, wherein each tile comprises:
(i) a first layer comprising a non-woven primary backing having pile elements tufted through the backing to form loops on an underside of the backing;
(ii) a second layer comprising a secondary backing and having loops provided substantially across the underside of the secondary backing for attachment to hooks of a hook and loop attachment system; and
(iii) hot melt binder which fastens the first and second layers to each other; wherein:
(iv) the tile is free of a stabilizing layer;
(c) installing the tiles sequentially in said side-by-side relation on the underlayment with the loops of the tiles in engagement with the hooks of the underlayment with adjacent unfinished cut edges in abutment with each other.

46. The method of claim 45, wherein the tile has unfinished cut edges.

47. The method of claim 45, wherein the tiles are defined according to claim 1, and wherein the hooked underlayment comprises a plurality of anchor sheets as defined in claim 42, in any combination of the elements of said claims.

48. The method of claim 45, including the steps of:
(d) providing a tool, the tool comprising a plate of low friction material having a first edge complementary to at least a portion of a first edge of a first said carpet tile for abutment thereagainst when the first tile is installed on the underlayment in step (c), dimensioned to permit situation of the plate on the hooks of the underlayment with subsequent placement of a second said tile thereon, to preclude premature engagement of the loops of the second tile and hooks of the underlayment during installation of the second tile in step (c); and
(e) prior to installing a second carpet tile in step (c) adjacent a previously installed tile, locating the tool with the first edge of the tool adjacent the first edge of the previously installed tile and situating the second carpet tile on the plate of the tool, and wherein step (c) includes withdrawing the plate of the tool from under the second tile while maintaining the second tile in said position to bring the loops of the second tile into engagement with the hooks of the underlayment.

49. The method of claim 48, wherein the tool is a hand-held tool and includes a handle for grasping the tool and withdrawing the plate in step (e).

50. A method of forming a join between carpet tiles, the method comprising the steps of:
(1) providing an underlayment for the tiles, the underlayment having hooks of a hook and loop attachment system across an upper surface thereof;
(2) providing first and second carpet tiles, wherein each tile comprises:
a decorative face comprising cut pile; and
loops of a hook and loop attachment system across an underside thereof; and wherein:
at least a portion of a cut unfinished edge of the first tile is shaped to be complementary with at least a portion of a cut unfinished edge of the second tile;
(3) locating the underlayment on a floor to be covered;
(4) securing the tiles on the underlayment by engaging the loops of the tiles with the hooks of the underlayment with the complementary edges adjacent each other; wherein the pile along each of the edges is tuft-bonded into a primary backing of the carpet and bevelled so that a trough is defined along the adjacent bevelled edges of the tiles.

51. The method of claim 50, comprising providing a third said tile wherein portions of cut unfinished edges of the second and third tiles are together complementary with a said cut unfinished edge of the first tile.

52. The method of claim 50, wherein the tiles are defined according to claim 1, and wherein the underlayment comprises a plurality of anchor sheets as defined in claim 42, in any combination of the elements of said claims.

53. A method of forming a plurality of carpet tiles for covering a pre-defined contiguous area of a floor of a site having a hooked underlayment installed thereon, the method comprising:
(a) providing a depiction of the area wherein the depiction includes a plurality of sections, each section corresponding to a said tile;
(b) providing a stock piece of carpet having loops provided substantially across an underside thereof;
(c) cutting the piece to form a tile to cover a said section;
(d) repeating steps (b) and (c) to provide a tile to cover each said section; and
(e) packaging the tiles for shipment to the site.

54. The method of claim 53, wherein in step (c), unfinished cut edges of the tile correspond to edges of the section, and step (d) includes assembling the tiles with said unfinished cut edges for shipment to the site.

55. The method of claim 53, wherein at least one of said sections is non-rectangular.

56. The method of claim 53, comprising the further step of removing pile along an edge of a tile formed in step (c) by shearing.

57. The method of claim 56, including the step of removing pile along an edge of the tile for each edge of a said tile which abuts an edge of an adjacent tile according to the depiction.

58. The method of claim 56, including the step of removing pile along an edge of the tile for each edge of a said tile which is on the perimeter of the area according to the depiction.

59. The method of claim 53, comprising the further step of shipping the assembled tiles to the site for installation.

60. The method of claim 53, comprising the further step of providing the underlayment.

61. The method of claim 53, wherein the underlayment comprises an anchor sheet according to claim 42.

62. The method of claim 53, wherein the carpet tile is as defined in any of claims 1.

63. The method of claim 53, wherein the carpet further comprises:
a first layer comprising a non-woven primary backing having pile elements tuft-bonded thereto; and
a second layer comprising a secondary backing and having loops provided substantially across the underside of the secondary backing for attachment to hooks of the underlayment.

64. A method of designing and manufacturing tiles of a carpet covering, the method comprising the steps of:
(a) providing access by a consumer to a computer programmed with graphics software capable of generating an on-screen depiction of a carpet covering comprised of a plurality of carpet tiles, wherein the carpet covering is selected from the group of carpet coverings consisting of: (i) a cut-pile carpet covering having substantially flat sections divided from each other by troughs; (ii) a cut-pile carpet covering having a plurality of sections in which neighboring sections are colored differently from each other; and (iii) combinations of (i) and (ii), wherein each section of the carpet covering corresponds to a said carpet tile, wherein:
the computer programme permits the user to manipulate the depiction of the carpet covering by varying the visual appearance of the sections of the depiction, and to select a desired depiction; and
(b) electronically storing a value associated with each of one or more parameters associated with each section of the selected depiction.

65. The method of claim 64, wherein in step (b), a said one or more parameters associated with each section is one or more of the shape of carpet tile corresponding to the section, the dimensions of the carpet tile corresponding to the section, the color of the carpet tile corresponding to the section, and the shape of each edge of the carpet tile corresponding to the section.

66. The method of claim 64, further comprising:
(c) providing a machine which can cut carpet pile, and which comprises a computer capable of controlling the cutting;
(d) loading the machine with a carpet piece having the color of a selected section of the selected depiction, wherein the carpet piece includes a first layer with a non-woven primary backing having elements of said cut pile tuft-bonded thereto; and a second layer having a secondary backing and having loops provided substantially across the underside of the secondary backing for attachment to hooks of hook and loop attachment system; and
(e) computer-controlled cutting of the carpet piece of (d), as necessary, according to values stored in step (b) associated with the selected section to form a carpet tile corresponding to the section, the edges thereof matching the edges of the section.

67. The method of claim 64, further comprising:
(f) providing a machine which can shear carpet pile located on the edge of a carpet piece, and which comprises a computer capable of controlling the shearing; and
(g) loading the machine of step (f) with a carpet piece having the color of a selected section of the selected depiction, wherein the carpet piece includes a first layer with a non-woven primary backing having elements of said cut pile tuft-bonded thereto; and a second layer having a secondary backing and having loops provided substantially across the underside of the secondary backing for attachment to hooks of hook and loop attachment system; and
(h) computer-controlled shearing of pile along one or more edges of the carpet piece of step (g), as necessary, according to values stored in step (b) associated with the selected section.

68. The method of claim 64, further comprising the step of providing the stored values as electronic input data to the computer of a machine capable of cutting carpet and/or shearing carpet pile for creating a carpet tile of a selected depiction according to said values.

69. The method of claim 66, further comprising repeating each of steps (d), (e), (f) and (g) as necessary for different selected sections of the selected depiction.

70. The method of claim 64, wherein said software pre-programmed with templates for said manipulation in step (a).

71. The method of claim 64 wherein said access is provided over the internet.

72. A carpet piece comprising a cut pile face, wherein: (i) the pile is a first color extending to a partial depth below the visible face and a second color therebelow, and (ii) the face is partially cut away to visually expose the second color when the carpet is viewed from above.

73. The carpet piece of claim 72, wherein the carpet is a carpet tile.

74. The carpet piece of claim 72, wherein the pile is at least ⅛″, or the pile height is up to I″, or the pile height is up to ¾″, or the pile height is up to ½″, and/or the pile height is at least ¼″, wherein the pile height can be ¼″, 1/2″, 3/4″, or 1″.

75. The carpet piece of claim 72, wherein the piece is a tile and the face is partially cut away along an edge thereof in the shape of a bevel.

76. The carpet piece of claim 75, wherein said carpet tile comprises a first layer in which said pile of the second color is tufted into a primary backing, a second layer comprising a secondary layer comprising a secondary backing and having loops provided substantially across the underside of the secondary backing for attachment to hooks of a hook and loop attachment system, the first and second layers are secured to each other by a hot-melt binder, and wherein the first color comprises a dye applied to the pile.

77. The carpet piece of claim 72 wherein said partial depth is up to 90% of the depth of the carpet pile, or wherein said partial depth is at least 10% of the depth of the carpet pile.

78. The carpet piece of claim 72, wherein said partial depth is between 20% and 80% of the depth of the carpet pile, or between 20% and 70% of the depth of the carpet pile, or between 30% and 80% of the depth of the carpet pile, or between 30% and 70% of the depth of the carpet pile, or between 40% and 70% of the depth of the carpet pile, or between 30% and 60% of the depth of the carpet pile, or between 40% and 70% of the depth of the carpet pile.

79. The carpet piece of claim 76, wherein said primary backing is a non-woven layer.

80. The carpet piece of claim 76, wherein said hot-melt binder is an EVA binder.

81. The carpet piece of claim 76, wherein the binder includes at most 50% by weight binder.

82. The carpet piece of claim 72, wherein there are at least two said first colors.

83. The carpet piece of claim 72, wherein the carpet piece is a carpet tile as defined according to any of claims 1 to 37 in any combination of the elements of said claims.

84. A method of manufacturing a carpet, the method comprising:
providing a stock carpet piece having a decorative face provided by pile of at least one first color;
coloring at least a portion of the face with at least one second color, which visually contrasts with the first color, to a partial depth of the pile;
trimming a portion of the pile colored in the coloring step away to create a first section having the first color in visual contrast to an adjacent second section of the second color when the carpet is viewed from above.

85. The method of claim 84, wherein said pile is cut pile.

86. The method of claim 84, wherein said carpet is a carpet tile, and the method further comprises cutting said carpet piece to form one or more said tiles.

87. The method of claim 86, wherein the step of trimming includes forming a bevel along an edge of the tile.

88. The method of claim 86 wherein, during the coloring step, there is said portion of the face within the bounds of each tile to be formed during the cutting step.

89. The method of claim 88 wherein there are at least two said second colors.

90. The method of claim 89 wherein, during the coloring step, the second colors are applied across substantially the entire pile face that is to form part of a said carpet tile.

91. The method of claim 84, wherein the pile height is at least ⅛″, and/or the pile height is up to 1″, or is about 1″, or is up to about ¾″, or is ¾″, is up to about or is ½″, or the pile height is at least ¼″.

92. The method of claim 84, wherein the coloring step includes dying said portion of the face by application of a liquid dye so as to penetrate the pile to said partial depth.

93. The method of claim 92, wherein said partial depth is up to 90% of the depth of the carpet pile.

94. The method of claim 93, wherein said partial depth is at least 10% of the depth of the carpet pile.

95. The method of claim 93, wherein said partial depth is between 20% and 80% of the depth of the carpet pile, or between 20% and 70% of the depth of the carpet pile, or between 30% and 80% of the depth of the carpet pile, or between 30% and 70% of the depth of the carpet pile, or between 40% and 70% of the depth of the carpet pile, or between 30% and 60% of the depth of the carpet pile, or between 40% and 70% of the depth of the carpet pile.

96. The method of claim 84, wherein the carpet comprises a first layer in which said pile is tufted into a primary backing, a second layer comprising a secondary layer comprising a secondary backing and having loops provided substantially across the underside of the secondary backing for attachment to hooks of a hook and loop attachment system, and the first and second layers are secured to each other by a hot-melt binder.

97. The method of claim 96, wherein said primary backing is a non-woven layer.

98. The method of claim 96 or 97, wherein said hot-melt binder is an EVA binder.

99. The method of claim 96, wherein the binder includes at most 50%. by weight binder.

100. The method of claim 86 wherein the cutting step includes cutting the carpet piece in a pattern such that, in a floor covering assembled from the tiles, there are first and second tiles of substantially identical shape to each other to permit interchange of the first and second tiles within the covering, and the coloring step includes coloring the first and second tiles in first and second configurations, different from each other, such that said interchange results in a different overall visual appearance of the floor covering.

101. A method of manufacturing a carpet covering, the method comprising:
(a) providing a carpet piece comprising:
(i) a first layer comprising a non-woven primary backing having pile elements tufted through the backing to form loops on an underside of the backing and the pile elements present a face of at least two colors when viewed from above;
(ii) a second layer comprising a secondary backing and having loops provided substantially across the underside of the secondary backing for attachment to hooks of a hook and loop attachment system; and
(iii) hot melt binder which fastens the first and second layers to each other; wherein:
(iv) the carpet is free of a stabilizing layer; and
(b) cutting the carpet piece in a pattern to form tiles that, in a floor covering assembled from the tiles according to the pattern, there are first and second tiles of substantially identical shape to each other to permit interchange of the first and second tiles, and the first and second colors are in different configurations on said first and second tiles, such that said interchange results in a different overall visual appearance of the floor covering.

102. The method of claim 101 wherein each tile formed in step (b) belongs to a pair of said first and second tiles.

103. The method of claim 101 wherein said pattern is a grid.

104. The method of claim 103, wherein said grid is a rectangular grid, and wherein said tiles formed in step (b) can be square.

105. The method of claim 101, further comprising the step of (c) shearing pile elements along edges of the tile such that in a said floor covering assembled from the tiles a trough is formed along adjacent edges of neighboring tiles.

106. The method of claim 101 wherein the carpet tile is as defined in any of claims 1 to 37.
